(19) United States
(12) Patent Application Publication
(10) Pub. No.: US 2010/0309112 A1
(43) Pub. Date: Dec. 9, 2010

(54) COLOR DISPLAY MATERIALS AND RELATED METHODS AND DEVICES

(76) Inventors: Aditya Rajagopal, Irvine, CA (US); Christopher I. Walker, Pasadena, CA (US); Saurabh Vyawahare, Pasadena, CA (US); Axel Scherer, Laguna Beach, CA (US); Thomas A. Tombrello, Altadena, CA (US)

Correspondence Address: Steinfl & Bruno, 301 N Lake Ave Ste 810, Pasadena, CA, 91101, US

(21) Appl. No.: 12/796,628

(22) Filed: Jun. 8, 2010

Related U.S. Application Data
(60) Provisional application No. 61/185,523, filed on Jun. 9, 2009.
(60) Provisional application No. 61/222,356, filed on Jul. 1, 2009.

(51) Int. Cl. G09G 3/34

(52) U.S. Cl. 345/107

(57) ABSTRACT

Pixel devices, comprising ink particles differing in electrical charge, mass and/or shape contained within a fluidic structure, and related arrays methods and systems.

### CROSS REFERENCE TO RELATED APPLICATIONS

The present application claims priority to U.S. Provisional Application No. 61/185,523, filed on Jun. 9, 2009, and U.S. Provisional Application No. 61/222,356, filed on Jul. 1, 2009, each incorporated herein by reference in their entirety.

### STATEMENT OF FEDERAL SUPPORT

The U.S. Government has certain rights in this invention pursuant to Grant No. HR0011-01-1-0054 awarded by DARPA and Grant No. DMR0520965 awarded by the National Science Foundation.

### FIELD

The present disclosure relates to imaging displays. More in particular, it relates to color display materials and related methods and devices, such as methods and devices for displaying color images with ambient light sources.

### BACKGROUND

As electronic imaging displays become more ubiquitous, there is an increased demand for low power consumption display technologies. In addition, there is a demand for display technologies which do not rely on an internal light source—displays which require only ambient light—allowing for easier visibility in high brightness conditions. An example of a display technology meeting both requirements is the E-Ink active matrix display. However, this technology is currently limited to black and white.

### SUMMARY

Provided herein are devices, and related arrays, methods and systems that in some embodiments, allow a variable reflectance element actuated through electrostatic means.

According to a first aspect, a pixel device is described. The pixel device comprises a fluidic structure, a plurality of ink particles, at least one transparent or translucent first electrode and at least one second electrode. In the pixel device, the plurality of ink particles comprise ink particles differing in electrical charge and/or mass contained within the fluidic structure. In the device, the element are configured so that a first electric field is generated when the first electrode and the second electrode are biased, causing the plurality of ink particles to selectively migrate toward the at least one first electrode according to the mass of the ink particles.

According to a second aspect a display device is described, that comprises an array of the pixel device herein described.

According to a third aspect, a method of ink particle stratification is described. The method comprises, providing a structure that contains at least one first electrode and at least one second electrode, configured to allow generation of a first electric field upon biasing of the at least one first electrode and the at least one second electrode. The method further comprises providing ink particles of identical charges but different masses; and biasing the structure; wherein the ink particles migrate toward the at least one first electrode.

According to a fourth aspect, a variable reflectance pixel device is described, the variable pixel device comprising: a substrate, a charged material, an insulating fluid, a conducting film, and an electrode. In the variable pixel device, the substrate has a top surface and a bottom surface, with at least one well, wherein the at least one well contains an opening at the top surface of the substrate. In the variable pixel device, the charged material is shaped to fit into, and contained within, the at least one well; and the insulating fluid is contained within the at least one well. In the variable pixel device, the conducting film is electrically insulated from the substrate, covers the top surface of the at least well; and the electrode contacts the bottom surface of the substrate.

According to a fifth aspect, a method of assembling a pixel array of a plurality of variable reflectance pixels is described. The method comprises: providing a substrate containing a plurality of differently shaped wells; and providing a block suspension containing at least one block of charged material of one or more shapes and an insulating fluid. The method further comprises selectively delivering the block suspension to the substrate, whereby the at least one block of charged material of one or more shapes become trapped in the plurality of differently shaped wells if the at least one pixel block of one or more shapes matches the shape of the plurality of differently shaped wells.

The devices, arrays, methods and systems herein described can be used in connection with electronic imaging display, e.g. liquid crystal display, or electrochromic display, laser technology and various additional applications identifiable by a skilled person upon reading of the present disclosure, wherein controllable positioning of particles is desirable.

The details of one or more embodiments of the disclosure are set forth in the accompanying drawings and the description below. Other features, objects, and advantages will be apparent from the description and drawings, and from the claims.

### BRIEF DESCRIPTION OF THE DRAWINGS

The accompanying drawings, which are incorporated into and constitute a part of this specification, illustrate one or more embodiments of the present disclosure and, together with the detailed description, serve to explain the principles and implementations of the disclosure.

FIG. 1, section A, shows a diagram of an electrophoretic ink capsule where a negative voltage is applied to the top electrode causing the positively charged black ink particles to migrate to the top of the capsule.

FIG. 1, section B, shows a diagram of an electrophoretic ink capsule where a positive voltage is applied to the top electrode causing the negatively charged white ink particles to migrate to the top of the capsule.

FIG. 1, section C, shows a diagram of an electrophoretic ink capsule where a negative voltage is applied to the top electrode causing the positively charged black ink particles to migrate to the top of the capsule.

FIG. 2 shows a diagram of a cross-sectional view of a microfluidic stratified chromatography cell, in accordance with the present disclosure, where a three-dimensional (3-D) microfluidic toroidal structure is filled with ink particles of identical charges but different masses. In the example shown in the figure, two sets of electrodes are used to chromatically separate the column of ink particles and to further separate ink particles in a direction perpendicular to the column.

FIG. 3A shows a schematic of an example of a variable reflectance pixel where the pixel is in the “on” state.

FIG. 3B shows a schematic of an example of a variable reflectance pixel where the pixel is in the “off” state.

FIG. 4 shows exemplary outlines of the shapes of wells for variable reflectance pixels.

FIG. 5 depicts two substrates with pixel wells, the upper one with an unmatched pixel well+pixel and the lower one with a matched pixel well+pixel.

FIG. 6 shows a pixel block containing three different colors.

FIG. 7A shows a top view of a pixel device according to an embodiment herein described.

FIG. 7B shows a cross sectional view of the pixel device of FIG. 7A along axis a-a in a passive assembly array comprising the pixel device of FIG. 7A (other devices not shown).

FIG. 7C shows a cross sectional view of the pixel device of FIG. 7A along axis a-a in an active assembly array comprising the pixel device of FIG. 7A (other devices not shown).

### DETAILED DESCRIPTION

Embodiments of the present disclosure are directed to devices, and methods to manufacture such devices, capable of providing analog color contrast and analog two-tone images, which utilize microfluidic stratified chromatography cells and variable reflectance pixels.

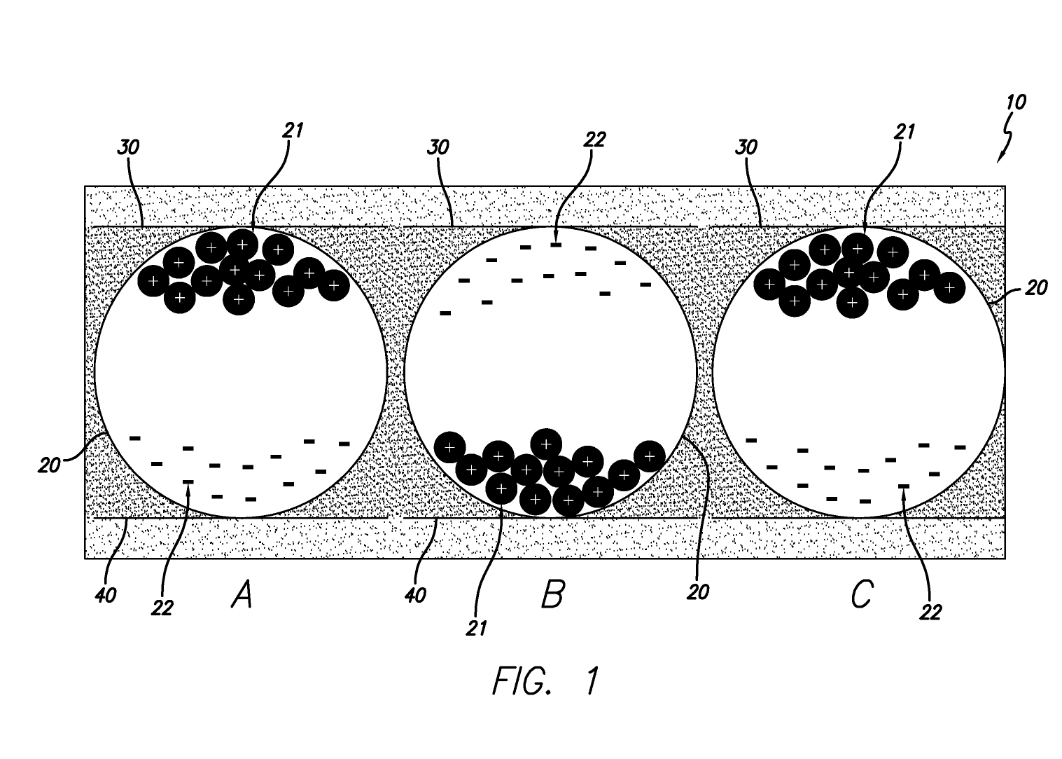

FIG. 1 shows an example of an electrophoretic ink capsule (10), where an array of pixels is fabricated out of small capsules (20). The capsules (20) contain a mixture of black (21) and white (22) ink capsules that are oppositely charged. By way of example, black ink capsules (21) are positively charged and white ink capsules (22) are negatively charged. The electrophoretic ink capsule further contains a top electrode (30) and a bottom electrode (40) positioned on top and bottom sides of the small capsules, respectively. The top electrode (30) is made of a transparent conductive material.

In the illustration of FIG. 1, when the top electrode (30) is actuated with an applied positive voltage, the negatively charged white ink particles are attracted to the edge of the top electrode (as depicted in FIG. 1, section B). These particles exhibit a much higher reflectivity when compared with the black ink particles. Therefore, the top of the display capsule (as seen by the user) appears white. When a negative voltage is applied to the top electrode (30), the positively charged black ink particles are accelerated to the top of the capsule (as depicted in FIG. 1, section A and FIG. 1, section C), resulting in low reflectivity at the surface. The user will then perceive this as “black”.

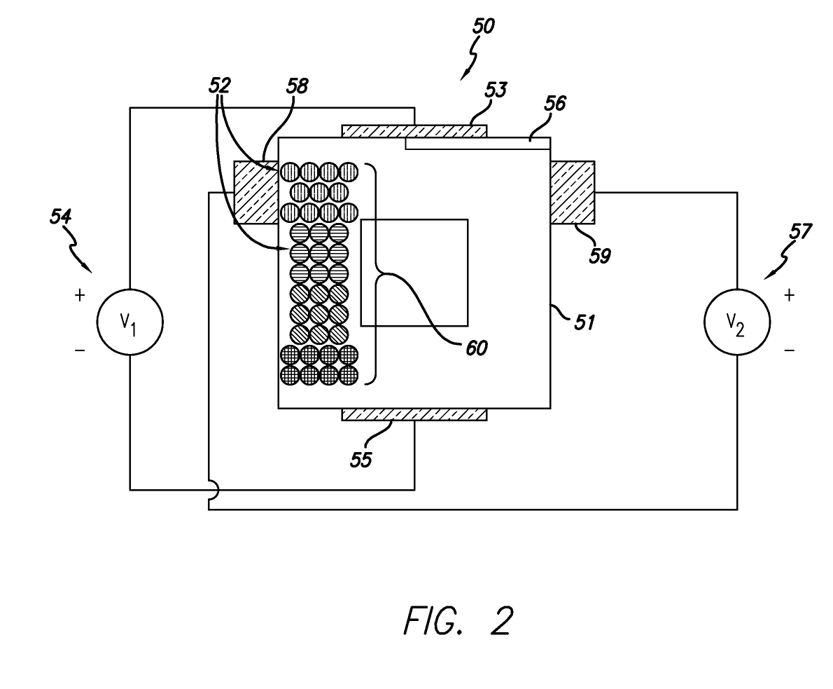

FIG. 2 shows an example of a pixel device herein described. In particular, FIG. 2 shows a cross-sectional view of a stratified chromatography cell (50) in accordance with an embodiment of the present disclosure, where a three-dimensional (3-D) structure (51) is filled with ink particles (52) of identical charges but different masses. The chromatography cell (50) is configured to allow a laminar flow of the particles (52), which can be performed, for example, when the chromatography cell (50) is configured for a microfluidic regime.

In the illustration of FIG. 2, the three-dimensional structure (51) is a toroidal structure. Additional shapes of structure (51) are comprised within the scope of the present disclosure as long as configured to allow an electrically driven and density matched flow of the particles could be used that are identifiable by a skilled person.

In the illustration of FIG. 2, the three-dimensional structure (51) comprises a plurality of particles (52). In particular, ink particles (52) of a first color have a first mass, ink particles of a second color have a second mass different from the first mass, ink particles of a third color have a third mass different from the first mass and second mass, and so on. in an embodiment, particles (52), can range in size from 10 nm diameter to 100 μm diameter. Additional ranges of dimensions are possible as long the dimensions of the beads and the volume allows a laminar flow of the particles (52). Also particles (52) can be of one or more colors according to the desired effect.

An analog voltage (54) can be applied to a top electrode plate (53), attracting the ink particles to the top surface of the structure of FIG. 2. The top electrode plate (53) is made of a transparent or translucent conductive material. Since the application of the voltage (54) will result in the generation of a constant electric field between the top electrode plate and the bottom electrode plate (55), each ink particle will experience a uniform force. However, since the particles are of different masses, each particle will experience an acceleration that is inversely proportional to its mass. As a result, the smallest particles will migrate to the top of the microfluidic structure, followed by the second smallest, and so on, and result in creating a column arrangement of colors based on size. In this manner, a mass-chromatography device in fluidics is generated.

In an embodiment, in the structure of FIG. 2, the chromatography is performed based on mass selection. Force=mass*acceleration. Yet, if the particles (52) are identically charged, a constant field will result in a constant Lorentz force (Force=q*E). Therefore, the acceleration of the particles (52) will be inversely proportional to the bead's mass. Assuming that the particles (52) have identical densities, the volume (or the size) of a bead is proportional to its mass. Therefore, acceleration will scale inversely with the volume of the particles (52).

In some embodiments, the top electrode plate (53) of the structure of FIG. 2 is fabricated out of a transparent or translucent conductor to allow for visibility of the ink particles (52) within the microfluidic structure (51). Additional portions of the structure (51) can be translucent or transparent according to the desired chromatographic and/or visualization effect. In some embodiments, particles (52) to be brought to the translucent or transparent portion have ink with high reflectance coefficients. A gradient can also be visualized by controlling the reflectance coefficient of the particles (52) so that it provides a desired effect from the transparent or translucent portion of the structure.

In some embodiments of the structure of FIG. 2, wherein a transparent or translucent top electrode (53) is comprised, an opaque thin film (56) can be included at the top surface of the microfluidic structure (51) under the top electrode (53) to allow for masking of ink particles (52) inside the structure, to make them not visible to the user. In some embodiments, the structure (51) is extruded from poly-di-methyl-siloxane (PDMS) or Parylene. Additional suitable material comprise Poly Vinyl Chloride (PVC), FR4, Kepton and additional material identifiable by a skilled person upon reading of the present disclosure.

In one embodiment, by selecting the corresponding masses/shapes and charges of the various ink particles (52) (e.g. white ink, 1 ng; blue ink, 2 ng; red ink, 3 ng), a desired resulting color can be displayed in the translucent and/or transparent portion of the device of FIG. 2, by applying a controlled voltage. Any number of colors and color combinations can be implemented in this method. In particular, an increase in the number and/or masses/shapes of the particles is associated typically to the possibility to obtain a color variation in connection with a smaller variation of the voltage applied. Accordingly, in some embodiments, timing and voltage are controlled to obtain a desired color variation and small variations of timing and voltage amplitudes are applied to display one or more desired color and/or a more diversified combination of colors as will be understood by a skilled person.

In an embodiment, a chromatically separated column of ink particles (60) (white on top, blue in the middle, and red on the bottom) can be generated. By applying a second electric field (57, 58, 59) perpendicular to the original electrode configuration of the top and bottom electrode plates, ink particles of unwanted colors can be “wicked” away from the column of ink particles such that the ink particles of unwanted colors are moved underneath the opaque thin film. This is achieved with the placement of electrodes (first side electrode (58) and second side electrode (59)) such that the second electric field only accelerates the upper portion of the chromatically separated column of ink particles (60). This process allows one to control the exact color seen by the user.

In particular, in an embodiment, the second “wicking” electrical field can be used to accelerate the charged particles (52) at the top of the cell by translation (in the x-y plane). In this way, the charged particles (52) at the top are moved to the portion of the cell that is opaque. However, since flow in the cell is laminar and since the fluid is density matched, the displacement of particles (52) at the top of the cell will force the beads right below them to move up. If another color is desired then another pulse of the vertical field can be applied to displace the particles over thus create that flow of particles that can be controlled to move the desired particles on the displaying portion of the cell.

In one embodiment, the microfluidic stratified chromatographic cell (50) can be used to create pixels for a more controlled analog two-tone display. For example, white and black ink particles of various masses and volumes (e.g. white ink particles of mass 1 ng, white ink particles of mass 2 ng, black ink particles of mass 1 ng, and black ink particles of mass 2 ng) can be placed in the microfluidic structure. Assuming that the white ink particles and black ink particles are both positively charged, with the white ink particles being more positively charged than the black particles, the careful application of an actuation voltage on the top electrode can be used to create a spectrum of shades. For example, with the application of a small positive voltage, only the less-massive white ink particles will be attracted to the top surface of the microfluidic structure, resulting in a pixel that is whitish. The application of a larger positive voltage will allow the more massive white ink particles and the less massive black ink particles to overcome the retardation due to the gravitational force, resulting in a much “grayish” pixel. Various tonalities can be achieved by controlling charges, masses of the ink particles in view of the voltage applied.

Additional variables that can be modified to control the color that is displayed comprise shape and volume of the particles (that can be varied among as long as the volume to mass ratio of the particles in a same cell is substantially the same), and the amount of charges for each particle which can be increased or decreased to have a desired acceleration upon application of certain voltage.

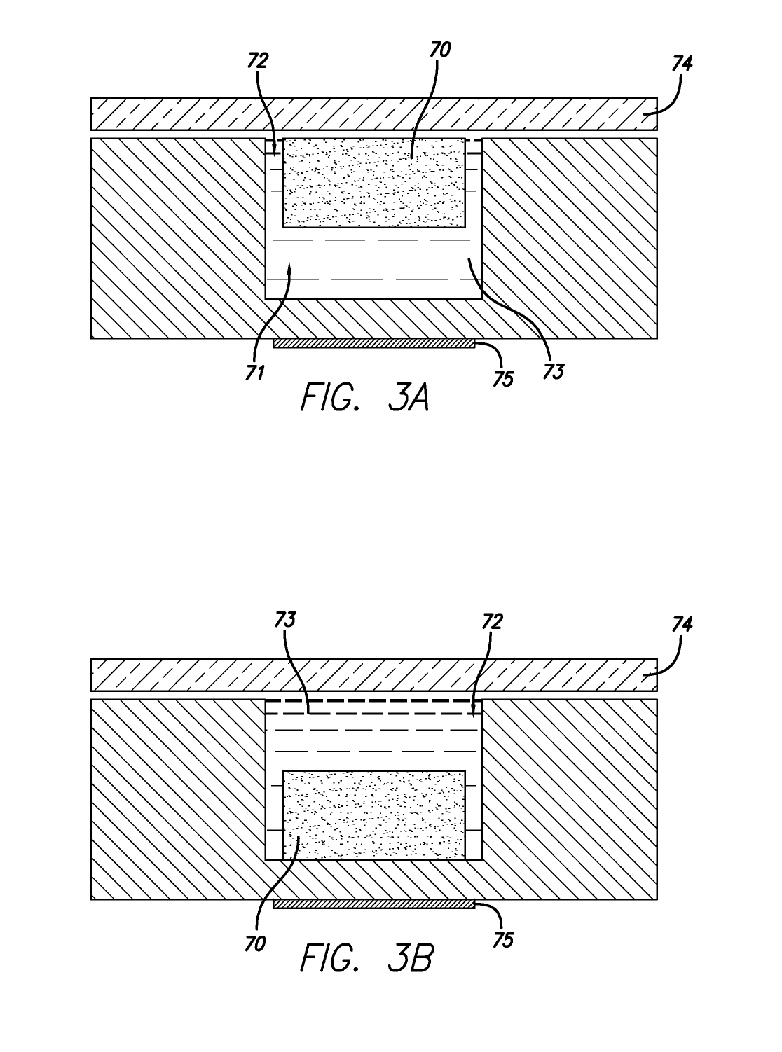

FIG. 3 shows an example of variable reflectance pixel device. In particular, FIG. 3A and FIG. 3B show an example of a variable reflectance pixel (70) in accordance with an embodiment of the present disclosure, where a substrate with a specially-shaped well (71) open at the top surface (72) contains a charged material (70) shaped to fit the well (71) and an opaque, insulating fluid (73). In particular, in the illustration of FIG. 3A and FIG. 3B, the opaque or slightly-translucent fluid (73) ensures that the two electrodes that contain the field (you can think of them as parallel plates of a capacitor), are not shorted. In the illustration of FIG. 3A and FIG. 3B, the opacity is neckwear to ensure that color is not seen through the side walls of the pixel. Fluid (73) can be a gas or a liquid and is included for insulating as long as the density of the fluid matches the density of the charged material (70).

In the illustration of FIG. 3A and FIG. 3B, the opening at the top surface (72) of the well (71) is capped with a transparent conducting film (74) that is electrically insulated from the substrate, ensures setting up the electric field from the contact to the substrate and allows visualization of the color ink particles.

Attached to the substrate, below the bottom surface of the well, a bottom electrode (75) is attached in order to create an electric field with the transparent conducting film (74) in view of the presence of insulating fluid (73). In particular, in the illustration of FIG. 3A and FIG. 3B, the transparent conducting film (74) provide the first contact, the bottom electrode (75) is the second contact and the insulating fluid (73) allows for there to be a field. The electrodes can be integrated using standard semiconductor fabrication techniques identifiable by a skilled person.

In the illustration of FIG. 3A and FIG. 3B, the specially-shaped well (71) and charged material (70) shapes are chosen such that the charged material is free to move up and down in the well, but is unable to rotate. In other embodiments, some or all of the charged material (70) can be allowed to rotate to the extent that the rotational symmetry is engineered in such a way that is compatible with the desired shape-well matching. In other word, the rotational symmetry is arranged so that the chances that a certain shape is matched with a non-corresponding well, according to the experimental designed, are minimized.

As would be understood by those skilled in the art, in the illustration of FIG. 3A and FIG. 3B, the charged material (70) can be constructed of a variety of materials, such as, but not limited to, silicon, plastics such as polyimide, metal and combinations thereof. Exemplary charged materials (70) comprise printed circuit board material, glass, and aluminum oxide and additional materials identifiable by a skilled person. The substrate can be constructed of a variety of materials, such as, but not limited to, silicon, plastics such as polyimide, metal and combinations thereof. Exemplary substrates comprise printed circuit board material, glass, and aluminum oxide and additional materials identifiable by a skilled person. The transparent conducting film (74) could be constructed of a variety of materials, such as, but not limited to, silicon, plastics such as polyimide, and combinations thereof. Exemplary transparent conducting films (74) comprise Indium Tin Oxide (ITO) and additional materials identifiable by a skilled person. The opaque, insulating fluid must be nonconductive and nonreactive with the materials chosen for the charged material, substrate and transparent conducting film. Silicone oils would function as an insulating fluid, but other nonreactive and nonconductive materials could be used.

In the illustration of FIG. 3A and FIG. 3B, when a voltage is applied between the substrate and the transparent conducting film, the resulting electric field moves the charged material (70) to/within the well (71). The two stable points are when the pixel is either at the top surface, in contact with the transparent conducting film, or at the bottom of the well, in contact with the substrate. For example, with a negatively charged pixel, applying a positive voltage between the transparent conducting film and the substrate will move the pixel up to the top of the well (as depicted in FIG. 3A for the “on” state). Since the substrate and transparent conducting film are insulated relative to each other, no current, other than the moving charge attached to the charged material, or pixel, flows between them, and thus no power is required to maintain the position of the pixel in steady state (as depicted in FIG. 3B for the “off” state).

The well depth is designed such that when the material (70) is at the bottom of the well (71), the material (70) is optically obscured by the opaque, insulating fluid. For example, with a white insulating fluid, with the material (70) at the bottom of the well (71), the top surface of the well (71) would appear white. However, with the pixel moved to the upper position against the transparent conducting film, the top surface would display the color of the material (70). Any other color can be used for the insulating fluid (73), according to the desired effect. For example, typically, a white or a gray (73) is desired for a “neutral” state.

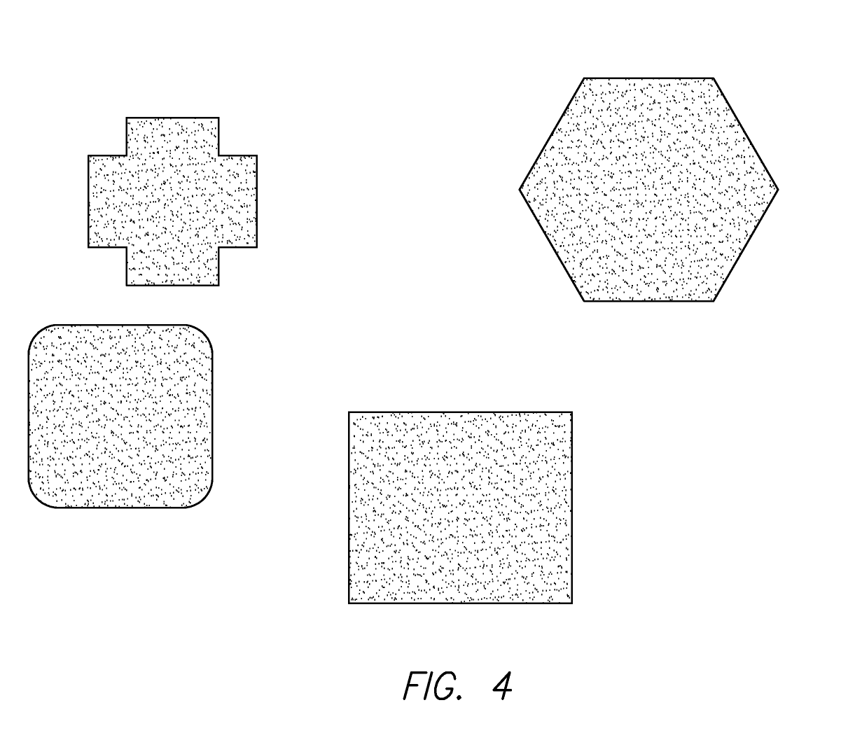

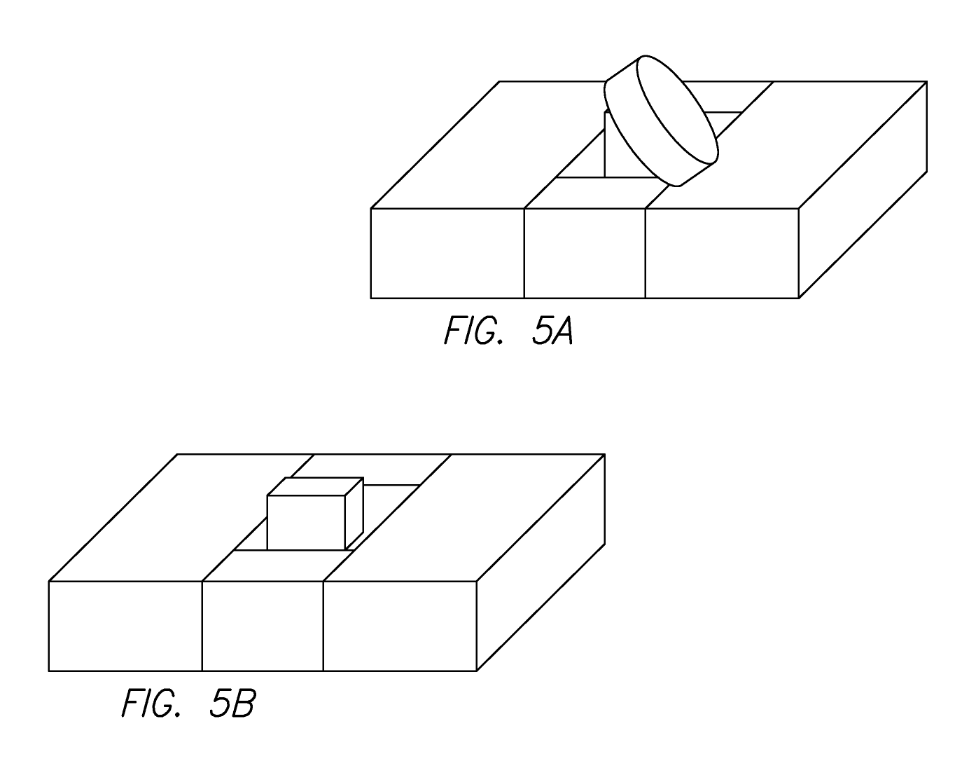

In some embodiments, the outline (top view) of the shape of the well (71) can take a variety of forms, as shown in FIG. 4. As would be understood by those skilled in the art, the shape of the well can be constructed in any form to accommodate a particular shaped pixel, as long as the pixel can freely move vertically (and/or rotationally, if desired) within the well. Multiple pixels and wells can be defined on the same substrate, with their shapes designed such that only the correct material will fit into its corresponding well, as depicted in FIG. 5.

In applications where visualization is desired, a pixel is provided by a cell comprising a plurality of wells (71) including a plurality of colored material (70) that is configured so that a desired color is displayed as a result of an applied voltage in the plurality of wells (71). In an embodiment, a cell includes a plurality of wells arranged in an array. A plurality of cells can also be arranged in an array used in connection with an application where a plurality of pixels is desired (e.g. LCD technology).

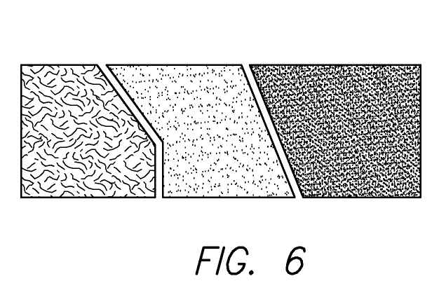

In some embodiments, a cell containing 3 different types of charged material in corresponding wells can be fabricated, as shown in FIG. 6. In an embodiment, this particular cell can be used to completely fill a plane when arrayed.

In an embodiment, the arrangement of FIG. 6 can be extended past three types of color. However, color generation is usually limited to mixing of integer ratios of red, green, and blue pixels (hence the 3 wells). A mat of these cells can be generated to create a functional display device. That is, we can just tile this cell in the x-y plane of the display surface.

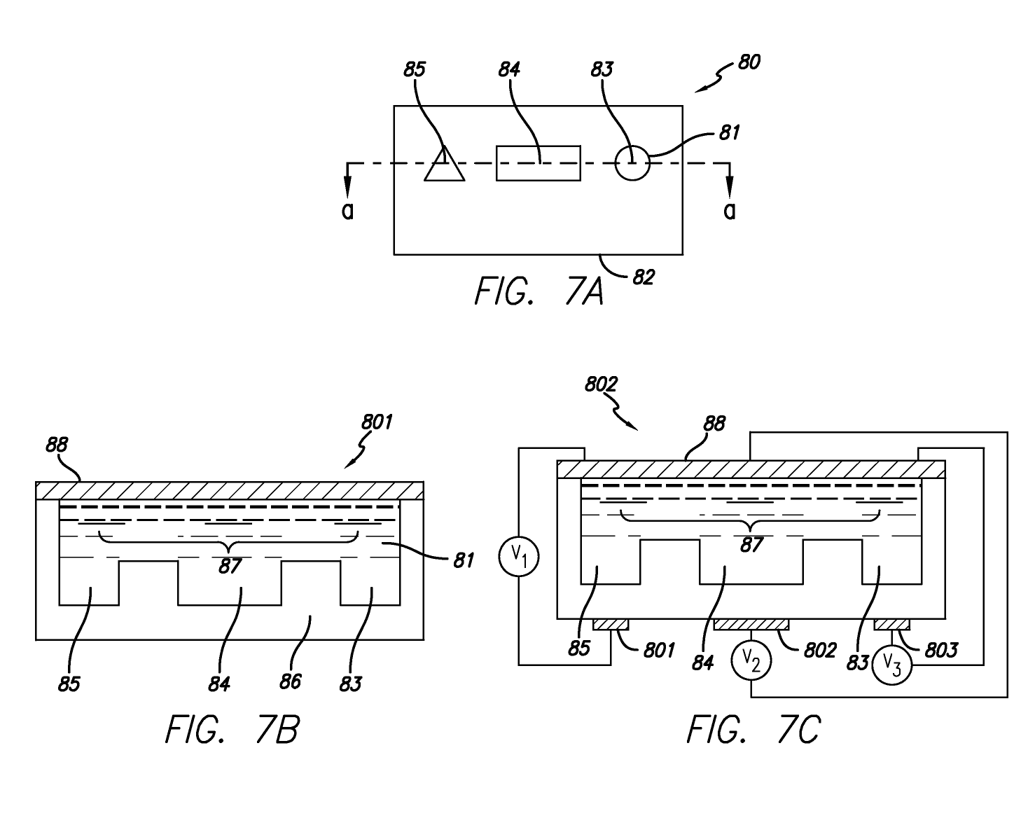

In an embodiment, a cell can contains wells of different shapes, in a configuration such as the one exemplified in FIG. 7A. In the illustration of FIG. 7A, the cell (80) having an inner wall (81) and an outer wall (82) comprises three differently shaped wells (83), (84) and (85) within a substrate and covered with a transparent or translucent material (88).

A cross sectional view of the display cell of FIG. 7A along axis a-a is also illustrated in FIG. 7B and FIG. 7C. In FIG. 7B, a display cell (80) is comprised as part of a passive assembly of pixel array (801), wherein cell (80) is comprised with other cells (not shown). Particles of charged material (87) are comprised within the cell covered by a top transparent or translucent material (88). the blocks having different shapes, each able to fit into one of the wells (83), (84) and (85). In a selective passive assembly, the blocks (87) float in a fluid and will randomly bounce off the surface of the substrate (86) until they hit a well of their type, at which point they will become trapped. In FIG. 7C, a display cell (80) is comprised as part of an active assembly (802) with other display cells (not shown). In the illustration of FIG. 7C, a top transparent or translucent contact (88) is coupled with a bottom contact (901), (902) and (903) located on the bottom of wells (83), (84) and (85) as illustrated. In this embodiment, a selective application of voltage to specific wells or groups of wells drives the different shapes (87) to the corresponding wells. In both the illustration of FIG. 7B and FIG. 7C, the particles not trapped in the wells will be visible through the transparent or translucent material (88).

According to an embodiment of the present disclosure, a method of passively assembling a pixel array of variable reflectance pixels is described. A fabricated substrate with many wells is used. The wells can be of a fixed set and combination of shapes (e.g. circles, triangles, squares, etc) for which there are corresponding material blocks. Each material block can fit into any well of its type (i.e. corresponding shape), but only wells of its type. The material blocks are mixed with an insulating fluid to form a solution of suspended material blocks. This solution is then delivered to the substrate (or the substrate is submersed in it). If the blocks are small enough for Brownian motion to agitate them, they will randomly bounce off the surface of the substrate until they hit a well of their type, at which point they will become trapped. In some embodiments, a voltage may be applied to the substrate, and ultrasonic agitation to the insulating fluid, to aid in this alignment process.

According to some embodiments of the present disclosure, a method of selectively assembling a pixel array of variable reflectance pixels is described. If independent electrodes are fabricated on each well, or on groups of wells, then the process may be performed as for passively assembling the pixels, with the addition of selective application of voltage to specific wells or groups of wells. This step will preferentially draw in the suspended pixel blocks. In some embodiments, one could use a set of solutions, each containing one type of pixel block, to flow over the substrate, while electrically activating only the desired wells in the substrate, resulting in the selective filling of an array with pixels. This process would allow the sequential filling of all of the types of wells on the substrate quickly, with a low likelihood of incorrect pixels becoming trapped on the substrate. As a non-limiting example, consider a system with two types of pixels (“A” and “B”) and a substrate with corresponding wells. First, voltage is applied to only the “A” wells on the substrate, and a solution containing only type “A” pixel blocks is placed in contact with the substrate. The “A” type pixel wells are then rapidly filled, with minimal interaction between the floating pixel blocks and the “B” type wells.

If an electrically selective assembly works with a low enough error rate, so that only electrically activated pixel wells are filled, then it is possible to fill an array of identical wells with an array of identically shaped, but differently colored material as will be understood by a skilled person. This is particularly possible if the trapped charge on a block material is adequate to create a shielding potential from a well (e.g. by virtue of the Couloumbic shielding phenomenon). If this is the case, the electric field decays across a characteristic distance known as the Debye length. The charge for the shape that fills the well, will “shield” the other charged shapes from the charge on the bottom of the well. Therefore, the chances that these other shapes can be accelerated to the bottom of the well are minimized. As a consequence, a filled well, even with voltage applied to it, can appear charge neutral to a suspended pixel block, and thus energetically unfavorable.

According to an embodiment, a method of assembling a color display of variable resistance pixels is described. First, an array of 3 or more types, i.e. shapes, of wells is fabricated in a substrate. The backside of the substrate is patterned with an array of electrodes aligned to the cells. In particular, a display cell consists of three or more “wells”, each corresponding to a single color. By controlling which wells are filled, the color displayed by the cell can be determined. The array is then filled with charged material blocks using one the fluidic assembly techniques described in one of the embodiments herein. There are 3 pixel block types, each with a corresponding color (red/green/blue). Once filled, the array can be capped with an electrically insulating film on which there is an array of a transparent conducting film (e.g. ITO), also aligned to the cells.

In particular, the spacing between the ITO and the substrate determines the field intensity for a given voltage. A first order approximation of this relationship is E-field=V/d, where V is the applied voltage between the ITO and substrate, and d is the spacing between the ITO and the substrate. Fields on order 1 MV/m are expected to be used for pixel actuation.)

By using the electrical arrays to apply voltage to selective pixels, the reflectance of each pixel in the array can be controlled as will be understandable by a skilled person. By controlling all of the pixels in this fashion, images in color can be displayed as will be understandable by a skilled person.

The description set forth above is provided to give those of ordinary skill in the art a complete disclosure and description of how to make and use the embodiments of the assembly, components, devices, systems and methods of the disclosure, and are not intended to limit the scope of the disclosure. Although any methods and materials similar or equivalent to those described herein can be used in the practice for testing of the assembly, components, device(s) and methods herein disclosed, specific examples of appropriate materials and methods are described herein.

Modifications of the above-described modes for carrying out the device(s) and methods herein disclosed that are obvious to persons of skill in the art are intended to be within the scope of the following claims. All patents and publications mentioned in the specification are indicative of the levels of skill of those skilled in the art to which the disclosure pertains. All references cited in this disclosure are incorporated by reference to the same extent as if each reference had been incorporated by reference in its entirety individually.

It is also to be understood that the terminology used herein is for the purpose of describing particular embodiments only, and is not intended to be limiting. As used in this specification and the appended claims, the singular forms “a,” “an,” and “the” include plural referents unless the content clearly dictates otherwise The terms “multiple” and “plurality” includes two or more referents unless the content clearly dictates otherwise. Unless defined otherwise, all technical and scientific terms used herein have the same meaning as commonly understood by one of ordinary skill in the art to which the disclosure pertains.

A number of embodiments of the device(s) and methods herein disclosed have been described. Nevertheless, it will be understood that various modifications may be made without departing from the spirit and scope of the disclosure. Accordingly, other embodiments are within the scope of the following claims.

1. A pixel device, comprising:
a fluidic structure;
a plurality of ink particles, comprising ink particles differing in electrical charge and/or mass contained within the fluidic structure;
at least one transparent or translucent first electrode and at least one second electrode, whereby a first electric field is generated when the first electrode and the second electrode are biased, causing the plurality of ink particles to selectively migrate toward the at least one first electrode according to the mass of the ink particles.

2. The pixel device of claim 1, wherein ink particles of a first mass and/or charge have a first color, ink particles of a second mass and/or charge have a second color different from the first color, and so on, whereby an ordered disposition of colors inside the device is obtained when the structure is biased.

3. The pixel device of claim 2, wherein the ink particles comprise white ink particles and black ink particles.

4. The pixel device of claim 2, wherein the first electric field controls the color of the ink particles to be located closest to the first electrode upon application of the first electric field.

5. The pixel device of claim 1, further comprising at least one third electrode and at least one fourth electrode, whereby a second electric field is generated when the third electrode and the fourth electrode are biased causing a subset of the plurality of ink particles to migrate toward the at least one fourth electrode and apart from the at least one transparent or translucent first electrode, thus hiding vision of the migrated ink particles and allowing vision through the transparent or translucent first electrode of the ink particles previous under the migrated ink particles.

6. The pixel device of claim 5, wherein the second electric field is perpendicular to the first electric field.

7. The pixel device of claim 1, further comprising an opaque film in contact with the microfluidic structure on the same side as the at least one first electrode.

8. A display device comprising an array of the pixel device of claim 1.

9. A method of ink particle stratification, comprising:
providing a structure, wherein the structure contains at least one first electrode and at least one second electrode, whereby a first electric field is generated;
providing ink particles differing in electrical charge and/or mass; and
biasing the microfluidic structure, whereby the ink particles migrate toward the at least one first electrode.

10. The method of claim 9, wherein the structure further contains at least one third electrode and at least one fourth electrode, whereby a second electric field is generated, wherein the second electric field is perpendicular to the first electric field, wherein the ink particles also migrate toward the at least one fourth electrode.

11. A variable reflectance pixel device, comprising:
a substrate, with a top surface and a bottom surface, with at least one well, wherein the at least one well contains an opening at the top surface of the substrate;
a charged material shaped to fit into, and contained within, the at least one well;
an insulating fluid contained within the at least one well;
a conducting film, that is electrically insulated from the substrate, covering the top surface of the at least well; and
an electrode contacting the bottom surface of the substrate.

12. The variable reflectance pixel device of claim 11, wherein the conducting film is transparent.

13. The variable reflectance pixel device of claim 11, wherein the insulating fluid is opaque.

14. A method of assembling a pixel array of variable reflectance pixels, comprising:
providing a substrate containing a plurality of differently shaped wells;
providing a block suspension containing at least one block of charged material of one or more shapes and an insulating fluid; and
selectively delivering the block suspension to the substrate, whereby the at least one block of charged material of one or more shapes become trapped in the plurality of differently shaped wells if the at least one pixel block of one or more shapes matches the shape of the plurality of differently shaped wells.

15. The method of claim 14, further comprising contacting at least one electrode on a backside of the substrate.

16. The method of claim 15, further comprising capping the plurality of differently shaped wells with an electrically insulating film.

17. The method of claim 15, further comprising capping the plurality of differently shaped wells with an electrically insulating film and an array of a transparent conducting film.

18. The method of claim 14, wherein the at least one pixel block of one or more shapes is a color selected from the group consisting of red, blue, green, white, black and mixtures thereof.

19. The method of claim 18, wherein the color is specific to a particular shape of the at least one block of charged material one or more shapes.

20. The method of claim 14, wherein the selectively delivering occurs by biasing a subset of the wells, thus trapping block of charged material having shapes matching the shapes of the biased wells and keeping blocks of charged material having shape not matching the shapes of the biased wells.
